(19) United States
(12) Patent Application Publication
(10) Pub. No.: US 2014/0246942 A1
(43) Pub. Date: Sep. 4, 2014

(54) STATOR FOR AN ELECTRICAL MACHINE

(71) Applicants: Stephen Greetham, Gloucester (GB); Mark Edward Leaver, Newcastle (GB); David Michael Jones, Gloucester (GB)

(72) Inventors: Stephen Greetham, Gloucester (GB); Mark Edward Leaver, Newcastle (GB); David Michael Jones, Gloucester (GB)

(73) Assignee: Dyson Technology Limited, Malmesbury, Wiltshire (GB)

(21) Appl. No.: 14/351,458

(22) PCT Filed: Dec. 23, 2011
(86) PCT No.: PCT/GB2011/052584

§ 371 Date: May 15, 2014

(30) Foreign Application Priority Data
Oct. 14, 2011 (GB) 1117771.4

(51) Int. Cl. H02K 3/18

(52) U.S. Cl. CPC H02K 3/18
USPC 310/208

(57) ABSTRACT

A stator comprising a plurality of stator elements, each stator element comprising a core and a coil wound about the core. The coil of at least one stator element is wound at angle such that the coil is sheared towards an adjacent stator element so as to reduce magnetic flux leakage between the two elements.

### REFERENCE TO RELATED APPLICATIONS

This application is a national stage application under 35 USC 371 of International Application No. PCT/GB2011/052584, filed Dec. 23, 2011, which claims the priority of United Kingdom Application No. 1117771.4, filed Oct. 14, 2011, the entire contents of which are incorporated herein by reference.

### FIELD OF THE INVENTION

The present invention relates to a stator for an electrical machine, and to an electrical machine incorporating the same.

### BACKGROUND OF THE INVENTION

The stator of an electrical machine may comprise a plurality of elements that are arranged around the rotor. Magnetic flux leakage between adjacent elements increases the inductance of the stator and decreases the torque acting on the rotor. Magnetic flux leakage is typically minimised through appropriate shaping of the stator elements. However, it is not possible to eliminate magnetic flux leakage altogether.

### SUMMARY OF THE INVENTION

In a first aspect, the present invention provides a stator comprising a plurality of stator elements, each stator element comprising a core and a coil wound about the core, wherein the coil of at least one stator element is wound at angle such that the coil is sheared towards an adjacent stator element so as to reduce magnetic flux leakage between the stator elements.

The coil of each stator element acts as a sheath or conduit for magnetic flux through the core. By shearing the coil of at least one stator element towards an adjacent stator element, magnetic flux leakage between the two elements is reduced. Accordingly, the inductance of the stator is reduced without any reduction in magnetic flux through the cores. Additionally, since less magnetic flux leaks between the two stator elements, more stator flux is able to link with a rotor and thus a greater torque may be exerted by the stator on the rotor.

Preferably, the coil of each stator element is sheared towards an adjacent stator element. This then further reduces the inductance of the stator and increases the torque exerted on the rotor.

The coil of the at least one stator element may have an inner side that extends along an inner perimeter of the core and an outer side that extends along an outer perimeter of the core. The outer side of the coil is then preferably sheared relative to the inner side of the coil in a direction towards the adjacent stator element. As a result, magnetic flux leakage at the outer perimeter of the cores of the two stator elements is reduced. When the stator elements are arranged about a rotor, this then encourages more of the stator flux to link with the rotor.

The shape of the coil may be that of a rectangular parallelepiped.

The at least one stator element preferably comprises a bobbin around which the coil is wound. The bobbin preferably comprises a tube and a pair of flanges, each flange extending from an end of the tube. The flanges lie in planes that are parallel to one another and are non-orthogonal relative to a longitudinal axis of the tube. The provision of a bobbin having a straight tube enables the coil to be wound about a straight section of the core. Moreover, since the flanges lie in non-orthogonal planes relative to the tube, the coil wound onto the bobbin is sheared. Accordingly, a sheared coil may be provided on a straight section of core.

The at least one stator element may comprise a further coil wound about the core at an angle such that the further coil is sheared towards an adjacent stator element. The coil and the further coil may be sheared towards the same or a different adjacent stator element. By providing a further coil, the magnetic flux through the core may be increased. By shearing the further coil towards an adjacent stator element, magnetic flux leakage between adjacent stator elements may be reduced.

The core of each stator element may be c-shaped and comprise a back, and two arms that extend from opposite ends of the back. A coil is then wound about one of the arms and a further coil is wound about the other of the arms. By employing c-shaped cores, a stator having four or more poles may be realised. Moreover, a relatively high fill factor may be achieved for each stator element. By providing a coil on each arm of the core, magnetic flux leakage between different parts of the same stator element may be reduced. The free end of each arm defines a pole face. Accordingly, when the stator elements are arranged about a rotor, magnetic flux leakage between adjacent stator elements will generally occur between the arm of one stator element and the arm of an adjacent stator element. By providing a coil on each arm of each stator element, magnetic flux leakage between adjacent stator elements may be reduced. Furthermore, by shearing a coil of at least one stator element, and preferably by shearing all coils of all stator elements, magnetic flux leakage between adjacent stator elements may be further reduced.

In a second aspect, the present invention provides a stator comprising a plurality of stator elements, each stator element comprising a core and a coil wound about the core, and the coil of at least one stator element is wound at angle such that the coil is sheared in a direction that reduces the inductance of the stator.

By shearing the coil of at least one stator element, the inductance of the stator is reduced without any reduction in magnetic flux through the cores.

In a third aspect, the present invention provides an electrical machine comprising a rotor and a stator as claimed in any one of the preceding paragraphs, wherein the stator elements are arranged around the rotor.

In a fourth aspect, the present invention provides an electrical machine comprising a rotor and a stator, the stator comprising a plurality of stator elements arranged around the rotor, each stator element comprising a core and a pair of coils, the core being c-shaped and comprising a back and a pair of arms extending from opposite ends of the back, wherein each coil is wound about a respective arm of the core and has an inner side that extends along an inner perimeter of the core and an outer side that extends along an outer perimeter of the core, and each coil is wound at an angle such that the outer side is sheared relative to the inner side in a direction towards the rotor.

By shearing the coils in this manner, magnetic flux leakage between adjacent stator elements is reduced at the outer perimeters of the cores. The inductance of the stator is therefore reduced without any reduction in magnetic flux through the cores. Additionally, since the stator elements are arranged around the rotor, more of the stator flux links with the rotor.

### BRIEF DESCRIPTION OF THE DRAWINGS

In order that the present invention may be more readily understood, an embodiment of the invention will now be described, by way of example, with reference to the accompanying drawings, in which:

FIG. 1 is a sectional view of an electrical machine in accordance with the present invention;

FIG. 2 is a sectional view of an electrical machine not in accordance with the present invention in which lines of magnetic flux leakage are shown; and

FIG. 3 is the same sectional view as FIG. 1 in which lines of magnetic flux leakage are shown.

### DETAILED DESCRIPTION OF THE INVENTION

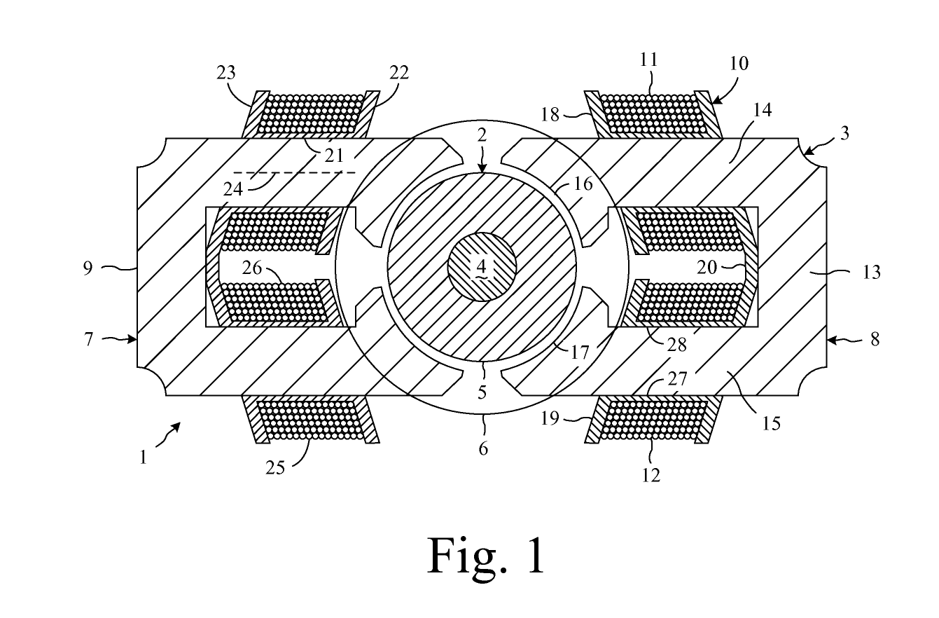

The electrical machine 1 of FIG. 1 comprises a rotor 2 and a stator 3.

The rotor 2 comprises a shaft 4 to which are mounted a four-pole permanent magnet 5 and a bearing (not shown). The bearing is located above the magnet 5 and is used to mount the rotor 2 to a frame 6 of the electrical machine 1. The portion of the frame 6 into which the bearing is seated overlies the stator 3 and is shown in outline only for the purposes of clarity.

The stator 3 comprises two stator elements 7,8 arranged on opposite sides of the rotor 2.

Each stator element 7,8 comprises a core 9, a bobbin element 10, and a pair of coils 11,12.

The core 9 is generally c-shaped and comprises a back 13 and two arms 14,15 that extend from opposite ends of the back 13. Each arm 14,15 extends toward the rotor 2 and has a free end that defines a pole face 16,17.

The bobbin element 10 comprises two bobbins 18,19 joined together by a bridging wall 20. Each bobbin 18,19 comprises a hollow tube 21, a forward flange 22 and a rearward flange 23, each flange 22,23 extending outwardly from an end of the tube 21. The flanges 22,23 of each bobbin 18,19 lie in planes that are parallel to one another and are non-orthogonal relative to a longitudinal axis 24 of the tube 21. The bridging wall 20 extends between and joins the rearward flanges 23 of the two bobbins 18,19.

Each bobbin 18,19 is provided on an arm 14,15 of the core 9. The frame 6, which overlies the core 9 of each stator element 7,8, limits the length of each bobbin 18,19 along an arm 14,15. The hollow tube 21 of each bobbin 18,19 surrounds the arm 14,15, the forward flange 22 is proximal to the pole face 16,17, and the rearward flange 23 is distal to the pole face 16,17. The hollow tube 21 surrounds a straight section of the core 9. The straight section may therefore be said to have a longitudinal axis that is coincident with that of the tube 21. The flanges 22,23 thus lie in planes that are non-orthogonal relative to the longitudinal axis of the section of the core 9 on which the bobbin 18,19 is provided.

Each coil 11,12 comprises a wire that is wound about a respective bobbin 18,19. A single wire may be used for both coils 11,12 of a stator element 7,8. Alternatively, separate wires may be used for each coil 11,12. Each turn of the coil 11,12 lies in a plane parallel to the flanges 22,23 of the bobbin 18,19. Consequently, each turn of the coil 11,12 lies in a plane that is non-orthogonal relative to the longitudinal axis 24 of the tube 21 and thus non-orthogonal relative to the section of the core 9 about which the coil 11,12 is wound.

Each coil 11,12 has an outer side wall 25 that extends along the outer perimeter 27 of the core 9 and an inner side wall 26 that extends along the inner perimeter 28 of the core 9. The coils 11,12 are wound at an angle such that the outer side wall 25 of each coil 11,12 is sheared relative to the inner side wall 26. Moreover, the outer side wall 25 is sheared relative to the inner side wall 26 in a direction towards the opposing stator element. The shape of each coil 11,12 about the core 9 may therefore be regarded as a rectangular parallelepiped.

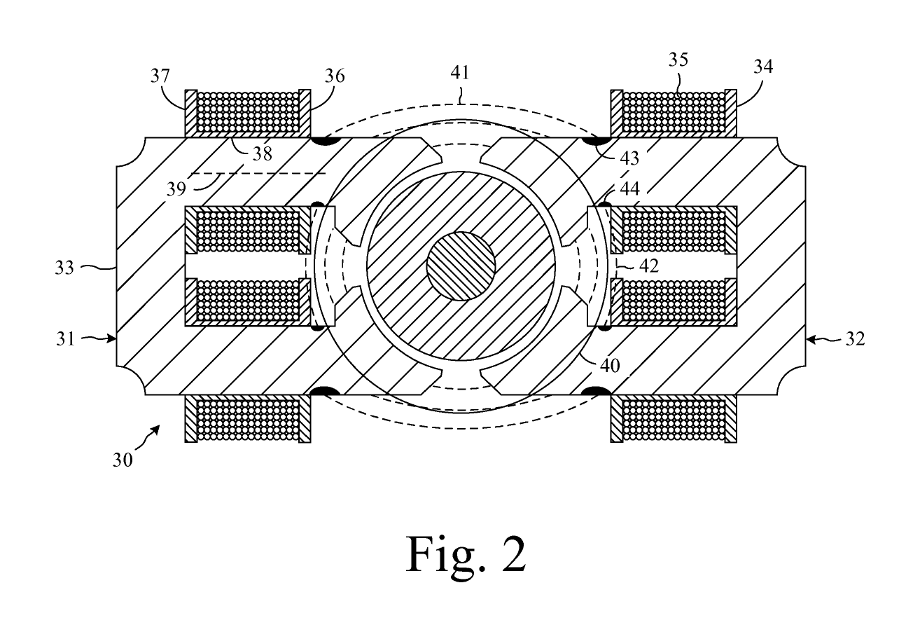

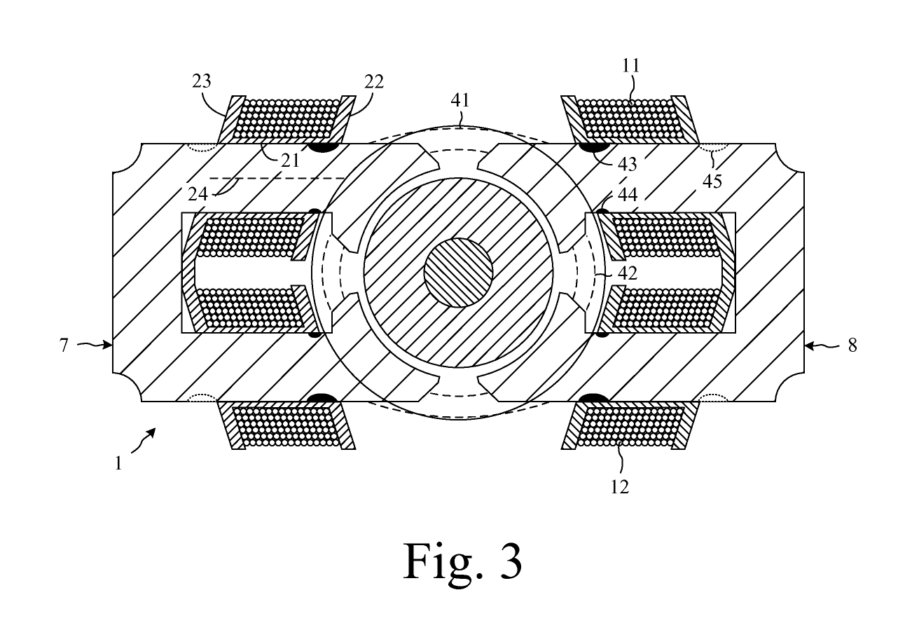

Each coil 11,12 acts as a sheath or conduit for magnetic flux through the core 9. Magnetic flux is therefore prevented from leaking from those sections of the core 9 about which the coils 11,12 are wound. By shearing the coils 11,12 of each stator element 7,8 towards the opposing stator element, magnetic flux leakage between the two stator elements 7,8 is reduced, as will now be demonstrated with reference to FIGS. 2 and 3.

FIG. 2 illustrates an electrical machine 30 that is identical in many respects to that described above and illustrated in FIG. 1. However, unlike the electrical machine 1 of FIG. 1, the flanges 36,37 of each bobbin 34 lie in planes that are orthogonal relative to the longitudinal axis 39 of the tube 38. Consequently, the turns of each coil 35 lie in planes that are orthogonal relative to the longitudinal axis of the section of the core 33 about which the coil 35 is wound. Again, the length of each bobbin 34 is limited by the frame 40.

Magnetic flux 41 leaks between the two stator elements 31,32 at regions of the cores 33 that are not covered by the coils 35. Additionally, magnetic flux 42 leaks between the two arms of each core 33 at regions that are likewise not covered by the coils 35. As a result of the way in which the coils 35 are wound, regions 43,44 are exposed on the outer and inner perimeters of the core 33.

With the electrical machine 1 of FIG. 1, each coil 11,12 is sheared in the direction of an opposing stator element 7,8. Consequently, the regions 43,44 that were exposed in the electrical machine 30 of FIG. 2 are now covered by the coils 11,12, as shown in FIG. 3. As a result, magnetic flux is prevented from leaking at these regions 43,44. Magnetic flux leakage 41 between the two stator elements 7,8 is therefore reduced, as is magnetic flux leakage 42 between the two arms 14,15 of each stator element 7,8. As a result, the inductance of the stator 3 is reduced. Additionally, more stator flux links with the rotor 2 and thus a greater torque is exerted by the stator 3 on the rotor 2.

In shearing the coils 11,12 towards an opposing stator element 7,8, regions 45 are exposed at the rear of each core 9. However, the distance between each of theses exposed regions 45 and an adjacent stator element 7,8 is much greater than that for the exposed regions 43 of FIG. 2. As a result, there is a net reduction in magnetic flux leakage 41 between the two stator elements 7,8.

The rotor 2 of the electrical machine 1 of FIG. 1 comprises a shaft 4 to which are mounted a magnet 5 and a bearing (not shown). By mounting the bearing in close proximity to the magnet 5, a relatively compact rotor 2 may be realised. However, as a consequence, the frame 6 into which the bearing is seated imposes a constraint on the locations of bobbins 18,19. The rotor 2 may therefore be mounted within the electric machine 1 in other ways such that the frame 6 does not impose a spatial constraint. For example, the bearing may be spaced further from the magnet 5, or the diameter of the bearing and frame 6 may be reduced. Irrespective of whether the frame 6 imposes a constraint on the locations of the bobbins 18,19, the coils 11,12 of each stator element 7,8 are sheared towards an opposing stator element so as to reduce magnetic flux leakage 41 between the two stator elements 7,8.

The electrical machine 1 of FIG. 1 comprises a stator 3 having two stator elements 7,8 arranged on opposite sides of the rotor 2. However, the stator 3 may comprise any number of stator elements arranged around the rotor 2. Similarly, the rotor 2 may comprise any number of poles and need not comprise a permanent magnet 5. For example, the electrical machine may be a reluctance machine having stator elements arranged around an iron-core rotor having salient poles. Irrespective of the number of stator elements, the coils of each stator element are sheared towards adjacent stator elements so as to reduce magnetic flux leakage.

In the electrical machine 1 of FIG. 1, each coil 11,12 of each stator element 7,8 is sheared towards an adjacent stator element. However, a reduction in magnetic flux leakage 41 between stator elements 7,8 may be achieved by shearing just one coil of the stator 3. Accordingly, it is not essential that all coils of the stator 3 are sheared. Nevertheless, as more coils of the stator 3 are sheared, a greater reduction in magnetic flux leakage is likely to be achieved.

1. A stator comprising a plurality of stator elements, each stator element comprising a core and a coil wound about the core, wherein the coil of at least one stator element is wound at angle such that the coil is sheared towards an adjacent stator element so as to reduce magnetic flux leakage between the stator elements.

2. The stator of claim 1, wherein the coil has an inner side that extends along an inner perimeter of the core and an outer side that extends along an outer perimeter of the core, and the outer side of the coil is sheared relative to the inner side of the coil in a direction towards the adjacent stator element.

3. The stator of claim 1, wherein the shape of the coil about the core is generally that of a rectangular parallelepiped.

4. The stator of claim 1, wherein the at least one stator element comprises a bobbin around which the coil is wound, the bobbin comprising a tube and a pair of flanges, each flange extending from an end of the tube, and the flanges lie in planes that are parallel to one another and are non-orthogonal relative to a longitudinal axis of the tube.

5. The stator of claim 1, wherein the at least one stator element comprises a further coil wound about the core at an angle such that the further coil is sheared towards an adjacent stator element.

6. The stator of claim 1, wherein the core of each stator element is c-shaped and comprises a back and two arms that extend from opposite ends of the back, the coil is wound about one of the arms, and a further coil is wound about the other of the arms.

7. A stator comprising a plurality of stator elements, each stator element comprising a core and a coil wound about the core, and the coil of at least one stator element is wound at angle such that the coil is sheared in a direction that reduces the inductance of the stator.

8. An electrical machine comprising a rotor and a stator of claim 1, wherein the stator elements are arranged around the rotor.

9. An electrical machine comprising a rotor and a stator, the stator comprising a plurality of stator elements arranged around the rotor, each stator element comprising a core and a pair of coils, the core being c-shaped and comprising a back and a pair of arms extending from opposite ends of the back, wherein each coil is wound about a respective arm of the core and has an inner side that extends along an inner perimeter of the core and an outer side that extends along an outer perimeter of the core, and each coil is wound at an angle such that the outer side is sheared relative to the inner side in a direction towards the rotor.
